(19) United States
(12) Patent Application Publication
(10) Pub. No.: US 2009/0216866 A1
(43) Pub. Date: Aug. 27, 2009

(54) Diskless computer-to-remote storage server opeating system installation system and method

(76) Inventors: Ching-Tung Lu, Taoyuan (TW); Min-Hung Lok, Taoyuan (TW)

Correspondence Address: TROXELL LAW OFFICE PLLC;Suite 1404, 5205 Leesburg Pike, Falls Church, VA, 22041, US

(21) Appl. No.: 12/071,658

(22) Filed: Feb. 25, 2008

(51) Int. Cl. G06F 15/177

(52) U.S. Cl. 709/222

(57) ABSTRACT

A diskless computer-to-remote storage server operating system installation system and method, which uses a boot firmware and a network storage driver to establish disk connection with a logic unit space, enabling the operating system installation program to recognize a disk device for installation. The boot firmware is in charge of fetching network parameters. The storage driver is in charge of providing the installation program with network device operating function. The system and method of the invention eliminates the procedure of establishing a physical hard drive for making an operating system image for transmitting to the logic unit space, preventing an operation error due to being unfamiliar with the installation procedure. By means of eliminating image file making procedure, the invention greatly lowers the chance of human error during system establishment.

### BACKGROUND OF THE INVENTION

1. Field of the Invention

The present invention relates to a storage sharing technology and more particularly, to a diskless computer-to-remote storage server operating system installation system and method, which enables a diskless computer to install an operating system in a remote storage server.

2. Description of the Related Art

To a person in the information industry, it is a big burden to manage a big number of computer systems. Using diskless computers by means of a centralized storage control facilitates management of computer software and hardware and increases storage space utilization efficiency. The design concept of this architecture is to remove the hard drive from the computer and to connect the computer to a remote server through the network storage protocol for enabling the computer to obtain the desired disk drive information from the remote server for its operating system subject to a network storage access technology. This network data storage service is to share a block of storage space in the physical disk drive and to install the operating system related file in the block of storage space for booting the diskless computer.

FIG. 1 is a schematic drawing showing a network storage sharing system according to the prior art. According to this design, the network storage sharing system comprises a storage server 11, a network communication device (such as switch, router, or hub) 12, a plurality of diskless computers 131˜133, and a network 14. The storage server 11 and the diskless computers 131˜133 are connected to the network communication device 12 by means of the network 14 so that the storage server 11 and the diskless computers 131˜133 establish a network communication protocol for transmitting and receiving data therebetween. The diskless computers 131˜133 transmit a SCSI over IP or SCSI over FC network packet to storage server 11 for enabling the disk drive (not shown) to read or write disk data so that the storage server 11 sends the data or response through the network 14 to the diskless computer that sent the request.

FIG. 2 is a schematic drawing showing a diskless computer booting technique according to the prior art. According to this design, diskless computers referenced by 21, 210 and 211 are regular computer systems each comprising at least one microprocessor 22, a network interface 23, and a non-volatile memory 24. According to this design, each diskless computer does not have any hard disk drive, but uses a non-volatile memory 24 as a substitute. The non-volatile memory 24 has installed therein a boot firmware 26. The boot firmware 26 comprises a network storage driver 27, a network protocol driver 28, and a network interface driver 29. When the power of the diskless computer 21 is started, the BIOS (basic input output system) of the computer reads the boot firmware 26 from the non-volatile memory 24 and loads it to the main memory 25 of the computer for running. By means of the function of the boot firmware 26, the diskless computers 21, 210 and 211 utilizes the microprocessor 22 to run the boot firmware 26, thereby controlling the network interface 23 to establish connection with the storage server 213 through the network 212 during BIOS stage, so as to fetch data and operating system image files 215 and 217 from the disk devices 214 and 216 for enabling BIOS to run the operating system files and finishing the work of booting the operating system.

FIG. 3 is a schematic drawing showing the installation of an operating system image according to the prior art. According to this method, the PC (personal computer), referenced by 31, is a regular computer system connected with a CD-ROM 34 and at least one hard drive 32. The CD-ROM 34 is adapted for reading data from the operating system installation disk 35 for booting the computer system. The hard drive 32 is a disk device for storing the operating system 33a and other application programs 33b. After installation of the operating system, the PC 31 can utilize the hard drive 32 to boot the operating system 33a and to run the application programs 33b. For enabling diskless computers to boot the operating system, at least one of the aforesaid PC 31 is necessary. Because diskless computers utilize a storage server 36 to obtain a disk device and the file of the necessary operating system, the storage server 36 must have at least one disk image data pre-stored therein for booting. According to a common conventional method, a network 310 is used to copy the file of the operating system from the hard drive 32 of the PC 31 to the disk device 37 of the storage server 36 by means of an upload program. The pre-configured logic space 39 in the disk device 37 must correspond to the hard drive 32 so that all the disk data in the hard drive 32 can be completely copied to the logic spaces for further use as an operating system boot image 38.

The operating system boot image 38 comprises the data of the operating system core program, application program and user setting. After installation of the operating system in the hard drive 32, an upload tool is necessary to transmit the file content from the hard drive 32 to the logic space 39 in the network storage server. The data uploading can be performed through a bus to copy disk space, or to copy the operating system 33a and application programs 33b in the hard drive 32 to the logic space 39 in the disk device 37 via the network 310. By means of the network 310, one diskless computer can be connected to the network storage device to fetch the network disk space and the operating system program for starting the operating system or running application programs. Managing diskless computer operating system and application programs by means of disk image must upload the operating system 33a to the hard drive 32 to the network storage server 36. Therefore, this method requires a physical disk device 32 for the installation of the operating system 33a and application programs 33b so that other tool means is used to copy the content of the disk device wholly to the network logic space 39.

Further, managing an operating system by means of a disk image encounters an image file maintenance problem. When an application program in the image file is to be modified, it is necessary to access to the original physical disk device that provides the image file and then to upload the new disk image after modification. This operation procedure is quite different from a regular operating system installation procedure. It brings troubles to a computer management person. An operating error may occur easily. In case of damage of data during image file uploading, operating system booting will not be achieved.

Therefore, it is desirable to provide a method of directly installing an operating system in a network disk space during establishing of a diskless computer without through a data transfer or disk image uploading procedure, eliminating human error.

### SUMMARY OF THE INVENTION

The present invention has been accomplished under the circumstances in view. According to one aspect of the present invention, the diskless computer-to-remote storage server operating system installation system and method, which has a boot firmware installed in a diskless computer. The boot firmware comprises a network storage program, a network communication program and a network interface program. The boot firmware is loaded onto the main memory of the computer, after power startup of the computer, to fetch network parameters from the non-volatile memory or through the DHCP (Dynamic Host Configuration Protocol). The firmware actively connects the remote storage server to fetch the authorized disk device data. Thereafter, the computer keeps using the operating system installation CD to boot the computer and to run the operating system installation program carried on the CD.

According to another aspect, System determines whether or not the operating system installation program has network access capability or supports network protocol. If the installation program does not have network access capability, the system automatically load a compatible network interface driver, network communication driver and network storage driver. The network interface driver enables the computer to control the network controller. The network communication driver provides the upper-layer communication protocol network connection and network packet processing functions. The network storage driver is in charge of establishing connection to a network disk device and making communication with the operating system installation program. After the driver loading operation, the network storage driver establishes connection with the remote storage server subject to the connection data of the firmware, continuing the boot program control work. During this stage, the boot firmware maintains remote storage server connection data and connection capability for use during calling of the bottom-layer disk device data by the operating system installation program. When the network storage driver fetched disk device data from the remote storage server, it reports to the operating system installation program for enabling the operating system installation program to recognize one physical disk device. Thereafter, the operating system installation program directly formats the disk device and installs the operating system file.

The invention effectively lowers the difficulty in establishing a diskless computer. By means of applying the same basic operating system installation procedure, the user needs not to install a physical disk device and then to upload the content of the disk device onto the remote storage server or to make an operating system image file, i.e., the user can directly uses the operating system installation program to complete a diskless computer operating system installation work. The method of the present invention provides a diskless computer with a reliable system establishment flow, preventing diskless computer booting failure due to that the user made an erroneous operating system image because of being not familiar with the making of a disk image file, or forgot to upload the operating system file. Therefore, the invention greatly reduces the chance of operating error and simplifies the system operation procedure.

### BRIEF DESCRIPTION OF THE DRAWINGS

FIG. 1 is a schematic drawing showing a network storage sharing system according to the prior art.

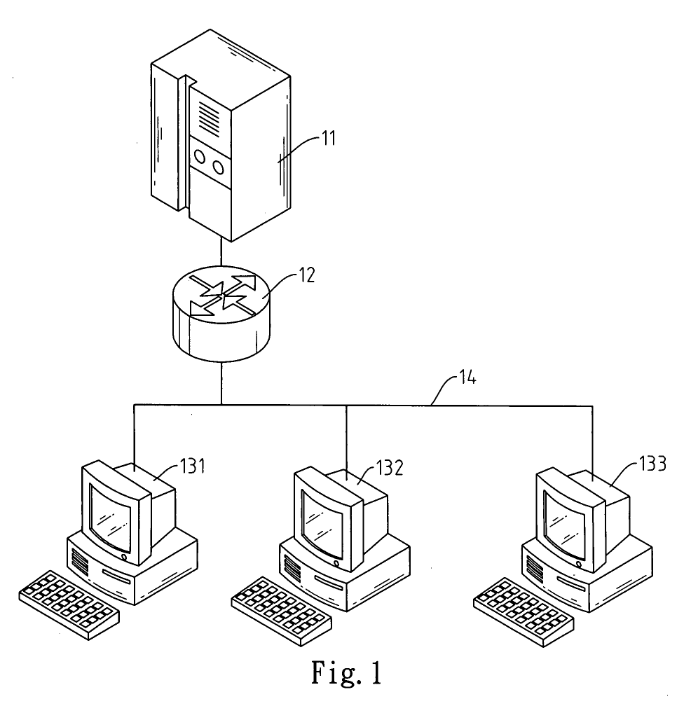

FIG. 2 is a schematic drawing showing a diskless computer booting technique according to the prior art.

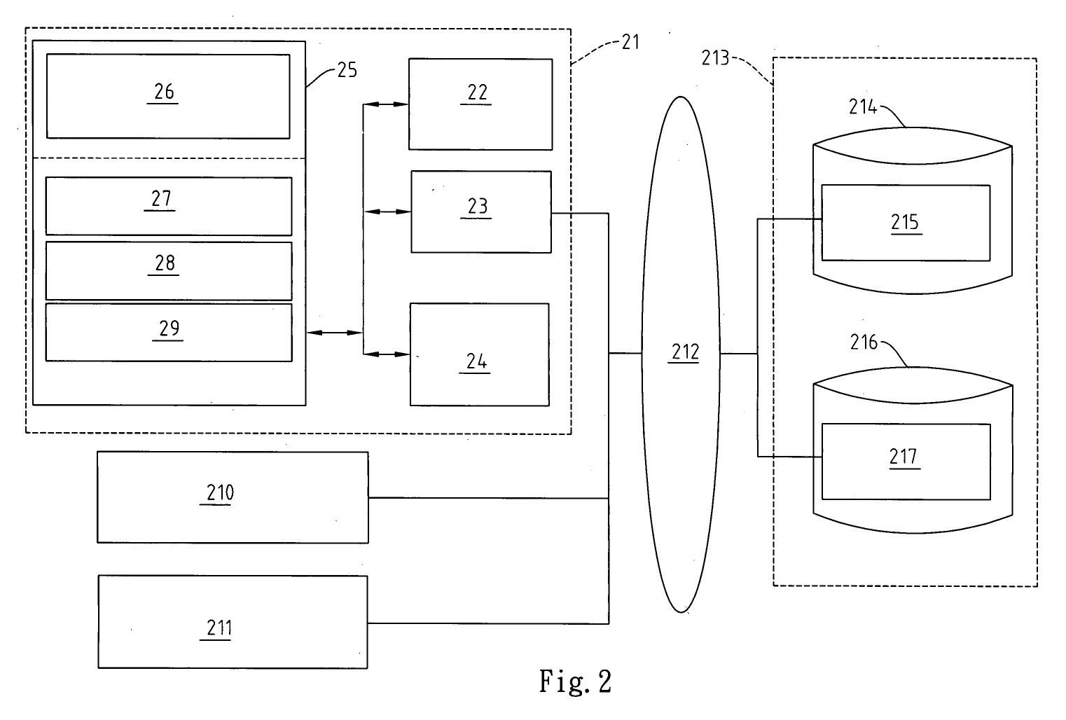

FIG. 3 is a schematic drawing showing the installation of an operating system image according to the prior art.

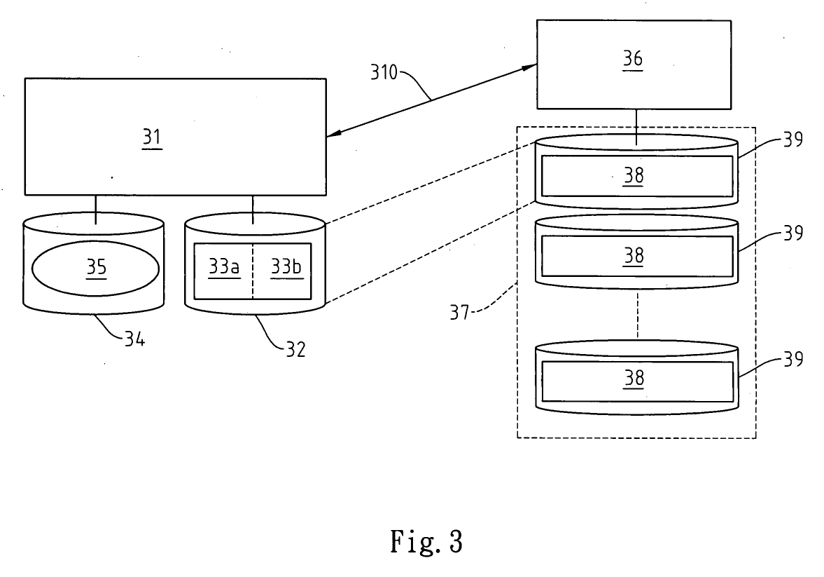

FIG. 4 is a system block diagram of the present invention.

FIG. 5 is a schematic drawing of the present invention showing the action between the operating system installation program and the boot firmware.

FIG. 6 is a system flow chart of the present invention

FIG. 7 is a flow chart of the present invention, explaining the diskless computer-to-remote storage server operating system installation procedure.

### DETAILED DESCRIPTION OF THE PREFERRED EMBODIMENT

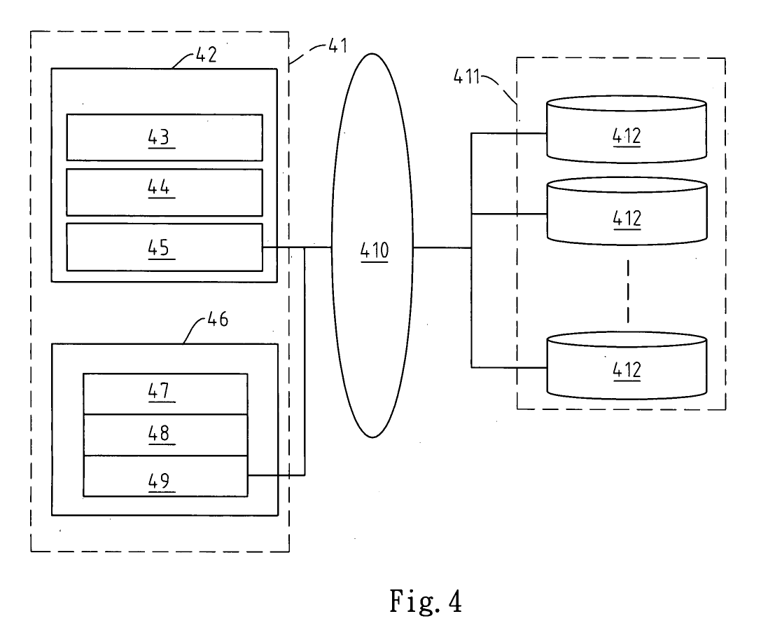

Referring to FIG. 4, a system for the installation of an operating system from a diskless computer to a remote storage server in accordance with the present invention is shown comprising a diskless computer 41, a storage server 411, and a network 410. The diskless computer 41 and the storage server 411 are respectively connected to the network 410. The network 410 can be the Internet or a LAN (local area network). It is to be understood that the present preferred embodiment comprises other function units. To simplify the figures and related description, the architecture shows only the related components, other components such as processor, memory device, network switch, router, and/or other network controllers of the diskless computer 41 and/or storage server 411 are not shown. Further, two or more diskless computers may be used in the system. The configurations of the diskless computer 41 and the storage server 411 are described hereinafter.

The storage server 411 is a computer server having data management and data storage capability. The storage server 411 comprises at least one processor and one main memory for running network 410 and disk control operation. According to the present preferred embodiment, the storage server 411 provides the diskless computer 41 with a disk device for booting the operating system and running related application programs. Therefore, the storage server 411 comprises at least one logic unit space 412 having installed therein the necessary operating system file and data for booting the diskless computer 41. The logic unit space 412 is the basic unit for identification of a respective disk space by means of a logic unit number. The storage server 411 configures multiple logic unit spaces 412, and gives a respective logic unit number to each logic unit space 412. The diskless computer 41 uses the respective logic unit number to identify the relationship of the fetched disk device relative to the storage server.

The diskless computer 41 can be the standard architecture of a standard diskless computer or server, comprising at least one processor, one input device, one memory, and one network controller. The network controller can be connected to a network switch or router to provide the diskless computer 41 with a network storage function. The diskless computer 41 has installed therein a boot firmware 46. The boot firmware 46 normally stored in a non-volatile memory at the computer motherboard, or directly inserted into the BIOS (basic input output system), for example, in the Boot ROM or PXE (Preboot Execution Environment). The boot firmware 46 is characterized in that when starting up the computer, BIOS automatically loads the boot firmware 46 to the memory for running. The boot firmware 46 is capable of controlling the said network controller to execute the related communication protocol during BIOS stage, for example, to fetch computer IP subject to DHCP (Dynamic Host Configuration Protocol) or to connect to the authentication server for account authentication. Further, the diskless computer 41 reads in an operating system installation program 42 from a VCD or DVD. The operating system installation program 42 is read and run by the input device of the diskless computer 41 for use as tool means for enabling the user to modify the setting of the operating system and to select the desired storage device. According to the present preferred embodiment, Microsoft Windows and Linus operating system are applied. Further, the installation program includes WinPE (Windows Preinstallation Environment).

The aforesaid boot firmware 46 has a network access characteristic for enabling the operating system installation program 42 to directly install the operating system file in the remote storage server 411. In actual practice, when the power of the diskless computer 41 is started up, BIOS fetches the boot firmware 46 from the non-volatile memory, and loads it to the memory of the diskless computer 41. The boot firmware 46 includes three main subprograms, i.e., the network storage program 47, the network communication program 48 and the network interface program 49. The network storage program 47 provides a function for the handling of the upper layer network storage communication protocol, for example, authentication of the connection between the diskless computer 41 and the storage server 411 and related data exchange. According to the present preferred embodiment, iSCSI (Internet Small Computer Systems Interface is employed for the network storage program 47. By means of the network storage program 47, the diskless computer 41 is connected with the storage server 411. The network communication program 48 is in charge of packet exchange work in the network layer, such as establishment, division, combination of network packets and maintenance of network connection subject to, for example, TCP/IP network communication protocol. The network communication program 48 receives network request from the network storage program 47, and transfers the request to the lower layer of the network interface program 49 for conversion into a network packet for transmission to the physical layer of the network 410. The network interface program 49 is a program capable of controlling the network controller, for example, Ethernet controller. The network interface program 49 is in charge of receiving and transmitting network packets. When the network controller of the diskless computer 41 receives a packet, the network interface program 49 fetches the packet from the buffer of the memory for processing, and then transmits the packet to the network communication program 48 after the network packet processing process has been done.

The aforesaid operating system installation program 42 is read into the memory by the input device for running. The input device can be a CD-ROM, network disk, or mobile disk. The operating system installation program 42 checks computer peripheral apparatus at first, and then loads the related drivers. The related drivers can be fetched from CD-ROM, floppy disk drive, external storage means, or network disk. The operating system installation program 42 includes three main subprograms, i.e., the network storage driver 43, the network communication driver 44 and the network interface driver 45. According to the present invention, the operating system installation program 42 may not have a network control function. Therefore, the diskless computer 41 must determine whether or not the operating system installation program 42 has a network communication function. The network interface driver 45 is in charge of the control of the network controller of the diskless computer 41. The network interface driver 45 provides the diskless computer 41 with network receiving and transmitting functions. The network communication driver 44 provides the diskless computer 41 with a network communication protocol handling function, including the function of proposing network communication protocol stack, such as, TCP (Transmission Control Protocol), UDP (User Diagram Protocol), IP (Internet Protocol) and ARP (Address Resolution Protocol). The network storage driver 43 is a program for communication with the remote storage server 411. The network storage driver 43 provides the diskless computer 41 with the function of fetching the data of the logic unit space 412 of the remote storage server 411 and giving a command to the logic unit space 412, and can communicate with the operating system installation program 42 to provide the operating system installation program 42 with a physical logic unit space 412.

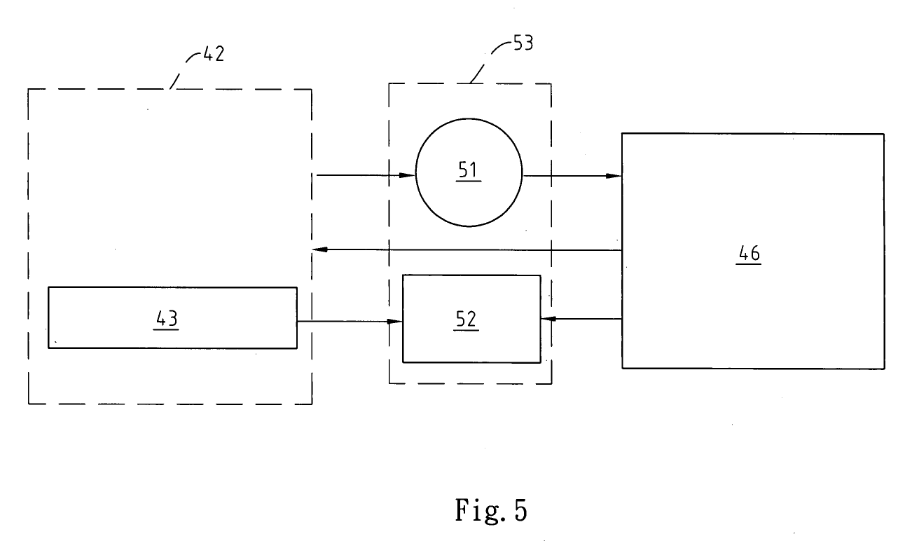

With respect to the communication between the aforesaid operating system installation program and boot firmware to obtain network parameters, please refer to FIGS. 4 and 5. FIG. 5 is a schematic drawing of the present invention showing the action between the operating system installation program and the boot firmware. As illustrated, the diskless computer 41 comprises a memory 53, and has installed therein a boot firmware 46 and also has fetched an operating system installation program 42 (from a VCD or DVD through an input device of the diskless computer 41). The operating system installation program 42 includes a network storage driver 43 for the handling of a network storage communication protocol. The boot firmware 46 includes a boot firmware table 52 for storing network parameters (such as the parameters of the IP address of the remote storage server 411 and the logic unit space 412). The boot firmware table 52 is recorded in the memory 53 of the diskless computer 41. The memory 53 can be the internal main memory of the diskless computer 41 or an external memory device connected to the diskless computer 41, having registered therein a disk interrupt vector 51.

After power startup of the diskless computer 41, BIOS loads the aforesaid boot firmware 46 to the memory 53 for running, enabling the boot firmware 46 to establish connection with the remote storage server 411 through the network 410 and to store the related network parameters in the firmware table 52 that is stored in the memory 53 of the diskless computer 41. Thereafter, the boot firmware 46 registers a disk interrupt vector 51 in the memory 53 of the diskless computer 41. According to this preferred embodiment, the interrupt vector is INT 13H. After registration of the disk interrupt vector 51, the boot firmware 46 is ready for operation. Thereafter, when the operating system installation program 42 started up the computer, the network storage driver 43 fetches the network parameters of the remote storage server 411 from the boot firmware table 52 provided by the boot firmware 46, and uses the network parameters to connect to the remote storage server 411. The operating system installation program 42 uses the disk interruption vector 51 to call the boot firmware 46 subject to the system design demand, thereby obtaining disk bottom layer data. At this time, the boot firmware 46 responds subject to the data fetched. Alternatively, the related disk data may be fetched from the remote storage server 411 through the network 410, and then a response is given to the operating system installation program 42.

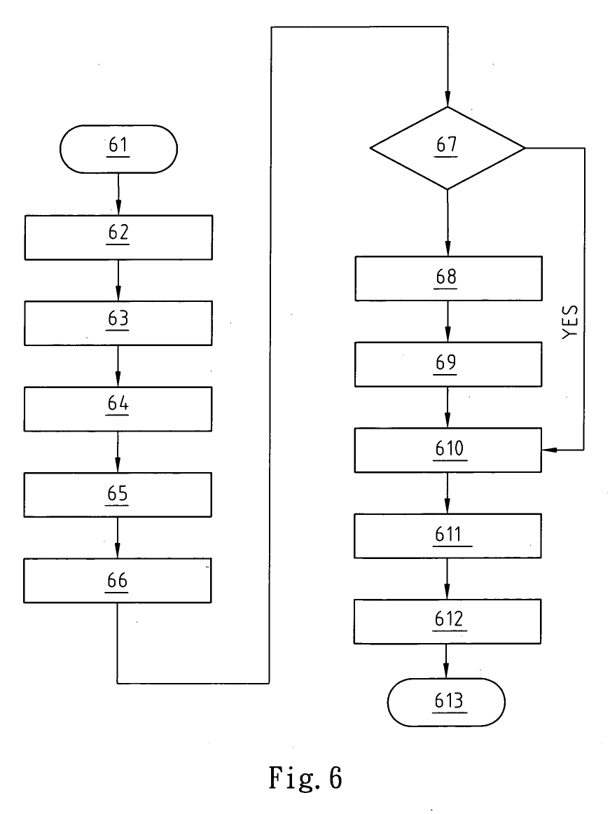

FIG. 6 is a system flow chart of the present invention in which the diskless computer and the remote storage server are respectively connected to the network. The storage server has a logic unit space. The diskless computer has stored therein a boot firmware table. The diskless computer further comprises a network controller. The method for the installation of an operating system from the diskless computer to the remote storage server installation method includes the steps of:
(61) Start up the power of the diskless computer;
(62) Bios of the diskless computer fetches the boot firmware from the non-volatile memory of the diskless computer and loads the boot firmware to the main memory;
(63) The boot firmware controls the network controller through the network interface program to establish network connection subject to the network communication program so that the boot firmware fetches the network parameters from the non-volatile memory or from DHCP server by means of DHCP communication protocol for enabling the network storage program and the logic unit space to establish connection to the network;
(64) The boot firmware records the network parameters in the boot firmware table and registers an interrupt vector;
(65) The boot firmware fetches at least one authorized logic disk unit from the logic unit space, and the diskless computer utilizes an input device, for example, CD-ROM to start up the diskless computer just because the logic unit space does not have an operating system file for booting the diskless computer;
(66) Load the operating system installation program to the main memory of the diskless computer and run the operating system installation program;
(67) System determines whether or not the operating system installation program has network access capability or supports network protocol, and then proceeds to step (68) when negative, or directly proceeds to step (610) when positive;
(68) Load the network interface driver to control the network controller of the diskless computer;
(69) Load the network communication driver to propose network communication protocol stack;
(610) Load the network storage driver to provide the operating system installation program with disk data and disk operation processing capability subject to, for example, iSCSI communication protocol;
(611) Establish connection to the logic unit space subject to the setting of the boot firmware wherein boot firmware network parameters are obtained subject to iBFT (iSCSI Boot Firmware Table defined by ACPI (Advanced Configuration and Power Interface);
(612) The operating system installation program obtains a physical disk device after connection of the network storage driver to the logic unit space, and then starts to format the disk device and to install the operating system file;
(613) The operating system installation work is done, and the flow is ended.

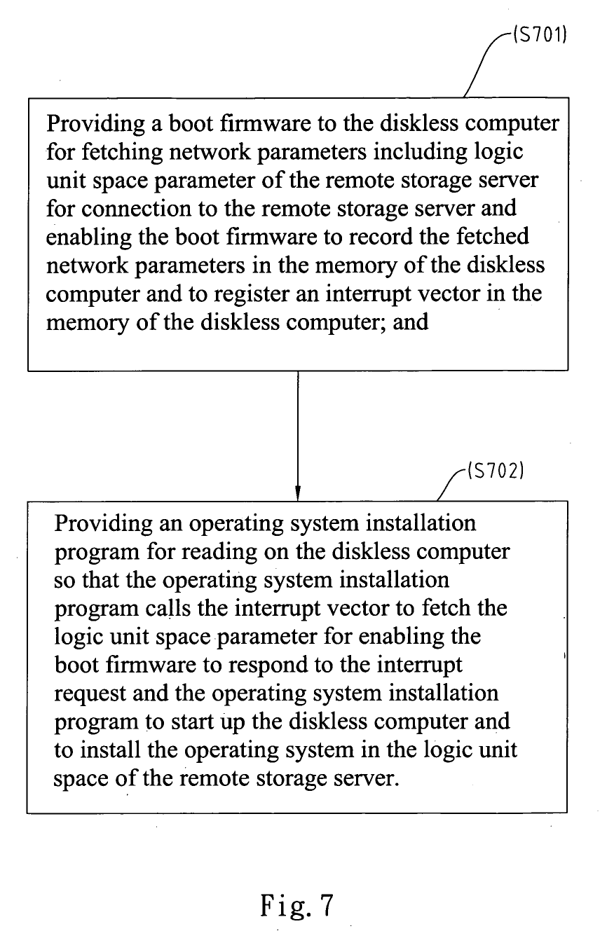

FIG. 7 is a flow chart of the present invention, explaining the diskless computer-to-remote storage server operating system installation procedure in which the diskless computer comprises a memory; the remote storage server comprises a logic unit space; the diskless computer and the remote storage server are respectively connected to a network. The method (procedure) includes the steps of:

Providing a boot firmware to the diskless computer for fetching network parameters including logic unit space parameter of the remote storage server for connection to the remote storage server and enabling the boot firmware to record the fetched network parameters in the memory of the diskless computer and to register an interrupt vector in the memory of the diskless computer; and

Providing an operating system installation program for reading on the diskless computer so that the operating system installation program calls the interrupt vector to fetch the logic unit space parameter for enabling the boot firmware to respond to the interrupt request and the operating system installation program to start up the diskless computer and to install the operating system in the logic unit space of the remote storage server.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A diskless computer-to-remote storage server operating system installation method for enabling a diskless computer to install an operating system in a remote storage server, said diskless computer comprising a memory, said remote storage server comprising a logic unit space, said diskless computer and said remote storage server being respectively connected to a network, diskless computer-to-remote storage server operating system installation method comprising the steps of:
(a) Providing a boot firmware to said diskless computer for fetching network parameters including the logic unit space parameter of said remote storage server for connection to said remote storage server and enabling said boot firmware to record the fetched network parameters in the memory of said diskless computer and to register an interrupt vector in the memory of said diskless computer; and
(b) Providing an operating system installation program for reading on said diskless computer so that said operating system installation program calls said interrupt vector to fetch said logic unit space parameter for enabling said boot firmware to respond to the interrupt request and for enabling said operating system installation program to start up said diskless computer and to install said operating system in said logic unit space of said remote storage server.

2. The diskless computer-to-remote storage server operating system installation method as claimed in claim 1, wherein said boot firmware is in charge of responding to the interrupt vector called by said operating system installation program.

3. The diskless computer-to-remote storage server operating system installation method as claimed in claim 1, wherein said boot firmware comprises a boot firmware table recorded in the memory of said diskless computer for storing network parameters.

4. The diskless computer-to-remote storage server operating system installation method as claimed in claim 1, wherein said operating system installation program comprises a network storage driver for enabling said diskless computer to fetch the logic unit space data of said remote storage server, to give a command to the logic unit space, and to provide the operating system installation program with a physical logic unit space.

5. The diskless computer-to-remote storage server operating system installation method as claimed in claim 1, wherein said operating system installation program comprises a network storage driver, a network communication driver and a network interface driver, said network interface driver enabling said diskless computer to receive and transmit data through said network, said network communication driver providing said diskless computer with a communication protocol management function, said network storage driver enabling said diskless computer to obtain the logic unit space data from said remote storage server and to give a command to said logic unit space and providing said operating system installation program with a physical logic unit space.

6. The diskless computer-to-remote storage server operating system installation method as claimed in claim 1, wherein said boot firmware comprises a network storage program, a network communication program and a network interface program, said network storage program providing an upper-layer network storage communication protocol processing function, said network communication program being in charge of the network layer packet exchanging work, said network interface program being in charge of network packet receiving and transmitting works.

7. The diskless computer-to-remote storage server operating system installation method as claimed in claim 1, wherein the memory of said diskless computer is the internal main memory of said diskless computer.

8. The diskless computer-to-remote storage server operating system installation method as claimed in claim 1, wherein the memory of said diskless computer is an external memory connected to said diskless computer.

9. A diskless computer-to-remote storage server operating system installation system comprising a diskless computer, a storage server, and a network, said diskless computer and said storage server being respectively connected to said network, wherein said storage server comprises at least one logic unit space; said diskless computer comprises a memory, a boot firmware installed therein and an operating system installation program fetched from an external source, said boot firmware being adapted for recording in said memory network parameters for connection to said storage server and registering an interrupt vector in said memory, said network parameters including a logic unit space parameter, said operating system installation program comprising a network storage driver, said network storage driver being adapted for calling said interrupt vector to fetch said logic unit space parameter, said operating system installation program being to start up said diskless computer, said logic unit space being adapted for enabling said operating system installation program to install said operating system in said logic unit space.

10. The diskless computer-to-remote storage server operating system installation system as claimed in claim 9, wherein said boot firmware comprises a network storage program, a network communication program and a network interface program, said network storage program providing an upper-layer network storage communication protocol processing function, said network communication program being in charge of the network layer packet exchange work, said network interface program being in charge of network packet receiving and transmitting works.

11. The diskless computer-to-remote storage server operating system installation system as claimed in claim 9, wherein said memory of said diskless computer is the internal main memory of said diskless computer.

12. The diskless computer-to-remote storage server operating system installation system as claimed in claim 9, wherein the memory of said diskless computer is an external memory connected to said diskless computer.

13. The diskless computer-to-remote storage server operating system installation system as claimed in claim 9, wherein said operating system installation program further comprises a network communication driver and a network interface driver, said network interface driver enabling said diskless computer to receive and transmit data through said network, said network communication driver providing said diskless computer with a network communication protocol processing function.
